(19) United States
(12) Patent Application Publication
(10) Pub. No.: US 2016/0134142 A1
(43) Pub. Date: May 12, 2016

(54) PORTABLE DEVICE CASE HAVING INTEGRATED WIRELESS CHARGING STATION

(71) Applicant: Joseph Murphy, Jupiter, FL (US)

(72) Inventor: Joseph Murphy, Jupiter, FL (US)

(21) Appl. No.: 14/938,089

(22) Filed: Nov. 11, 2015

Related U.S. Application Data
(60) Provisional application No. 62/078,089, filed on Nov. 11, 2014.

(51) Int. Cl. H02J 7/00; H02J 7/02; H04B 1/3888

(52) U.S. Cl. CPC H02J 7/0044; H04B 1/3888; H02J 7/025

(57) ABSTRACT

A protective case for a portable device includes an external charging ports and an external charging station. An internal charging plug attaches to a portable device housed within the case. When power is supplied to the case, it may supply power and thereby charge a phone within the case or may supply power to the charging station in order to charge a secondary device. The charging station may include an inductive charging mechanism for use with secondary devices that may be charged by induction without direct physical electrical communication. The protective case may include its own internal ancillary battery. The protective case may optionally be used to charge a secondary device using power supplied by the battery of the phone housed inside it. The protective case may also be used to charge the phone of the housed battery using power supplied from a device adjacent to its external charging station.

### CROSS-REFERENCE TO RELATED APPLICATIONS

This application claims priority to U.S. Provisional Application Ser. No. 62/078,089 filed on Nov. 11, 2014, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

1. Field of Endeavor

The present invention relates to systems and methods for wireless inductive charging of small portable devices. More particularly, the invention relates to a mobile phone case that may also be used as an inductive charging station.

2. Background Information

Inductive charging, also known as wireless charging, uses an electromagnetic field to transfer energy between two objects. This is usually done with a charging station. Energy is sent through an inductive coupling to an electrical device, which can then use that energy to charge batteries or run the device. Wireless chargers typically use an induction coil to create an alternating electromagnetic field from within a charging base station, and a second induction coil in the portable device takes power from the electromagnetic field and converts it back into electrical current to charge the battery. The two induction coils in proximity combine to form an electrical transformer. Greater distances between sender and receiver coils can be achieved when the inductive charging system uses resonant inductive coupling.

With the popularization of small size and powerful electronic devices, electronic wrist watches are not only used to show time, but also integrated with various auxiliary functions, such as audio playing function, near field communication (NFC) identification function, or GPS locating function. However, with addition of these auxiliary functions, power consumption is also increased. Therefore, expanding the capacity of a battery of the electronic wrist watch and simplify the charging process of the battery, without affecting the size of the electronic wrist watch are several of important aspects in manufacturing.

Portable battery operated electronic devices, such as cell phones, employ rechargeable batteries that must be recharged frequently. Typically, charging of electronic devices involves physical connection to a power source a charging cord. These devices are often protected by a case. A typical portable device case provides an opening through which a phone's charging port may be accessed by a charging cord so that it may be plugged in and recharged. Often a charging cord connects to a device through a mini- or micro-USB port at the end of a cable. The other end of the cable is then plugged into a computer USB port or a USB port on an adapter that may be plugged into a wall.

More recently, wireless charging devices such as inductive, magnetic resonance, and conductive pad chargers are available to charge the battery without any physical wire connection between the electronic device and the charging device. Inductive or magnetic resonance wireless chargers generate an electromagnetic field through the use of electromagnetic transducers to transfer the electric energy from the charging device to a receiver on a battery or device managing battery charging.

While smartphones and other relatively large devices have seen a great improvement in battery life, very small devices, such as smart watches, still have very limited batteries and often require more frequent charging. A charging station or plug may not be readily available when the batteries of these secondary devices die. In addition, charging two devices simultaneously requires two separate plugs.

Another problem encountered in the prior art is the absence of standardized charging ports. Different phones and devices use different types of plug and socket configurations. As a result, a device loses power at a time and place having only incompatible plugs.

In view of the foregoing, there is a need to provide means for charging portable devices and phones simultaneously from a single power source.

It is therefore desirable to provide a device or system for using a phone to charge a secondary device.

It is also desirable to provide a means for adapting a cell phone so that it may be charged by any type of charging cord.

### BRIEF SUMMARY OF THE INVENTION

Accordingly, the primary object of the present invention is to provide a mobile device case capable of charging devices via an inductive charging station.

In greater detail, a protective case for a portable device comprising a case, a mobile device inside the case, a port for receiving a charging cord, an external inductive charging station, a plug for engaging the charging port of the mobile device inside the case, a control pad, and internal circuitry electrically connected to the port, the plug, the inductive charging station, and the control pad.

In one embodiment, the protective case for a portable device includes a case having an internal cavity for holding a portable device defined by a back and a peripheral wall substantially perpendicular to the back and extending about the periphery of the back. The case has and external charging port for connecting to a charging cord and an internal charging plug for attachment to a charging port of a device housed within the case. The case also includes an external wireless charging station that may include an inductive charging mechanism and may be used to charge a secondary device. The case may include an internal ancillary batter. One or more tabs may be positioned about the charging station to hold a secondary device in place adjacent to the charging mechanism. A control pad may be located on the exterior of the case and may be used to switch the case to different modes, regulating which devices are charged and in what order and may also be used to select the source of power used to charge a battery or device. The case may include more than one external charging port for accommodating plugs of different charging cords.

It is therefore an object of the present invention to provide a case that uses one external charging port and an external charging station to provide charging to both a phone within the case, a secondary device and an internal ancillary batter. It is also an object of the present invention to provide a case that uses one charger connection and provides charging to both the phone and the watch.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a portable device case having a charging station in accordance with the principles of the invention;

FIG. 2 is a perspective view of a the back of a portable device case having a charging station in accordance with the principles of the invention;

FIG. 3 is a perspective view of the front of a portable device case having a charging station in accordance with the principles of the invention;

FIG. 4 is a cross-sectional side view of a portable device case having a charging station in accordance with the principles of the invention;

FIG. 5 is a cross-sectional side view of an alternative embodiment of a portable device case having a charging station and a secondary device in accordance with principles of the invention;

FIG. 6 is a cross-sectional front view of another alternative embodiment of a portable device in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Disclosed is a case for a mobile phone or other portable device having an integrated wireless charging station. The integrated wireless charging station may be used for charging a secondary device. A “secondary device” may typically refer to a smart watch, an e-cigarette or vapor device, mp3 players, headphones, heart-rate monitoring wrist bands, wearable “smart” devices, cell phones or other device capable of being recharged by an inductive wireless charging station. Where a smart watch is used herein to describe the principles of the invention, it should be understood that this is only exemplary and “smart watch” is generally interchangeable with “secondary device.” The numbers and types of secondary devices continues to grow and the invention is not limited to rechargeable watches.

A case having a charging station is described herein making reference to a phone and a phone case. However, these terms are not limiting. A phone is one of many types of portable electronic devices and is only used as an example of these types of devices. Therefore, “phone” as used herein as interchangeable with the term “handheld device” and/or “portable electronic device” which may encompass mobile phones, computer tablet, laptop computers, music playing devices and other portable devices. Similarly, “case” may refer to a case for a phone, a laptop, tablet or other portable or hand held device. It is understood that the phone and phone case may be substituted with a tablet and tablet case, or any other portable device and portable device case.

The case may include an external charging port to which a charging cord may be plugged. Electric current provided by through the charging cord may charge the phone in the case and also to supply current to an inductive charging station simultaneously. Optionally, in the absence of a power supplied by a charging cord, the inductive charging station may be supplied electric current from the phone's battery.

A secondary portable device may be charged by placing it on the charging station. The portable device case and/or device to be charged may include mechanisms to secure attachment to of a device to the charging station.

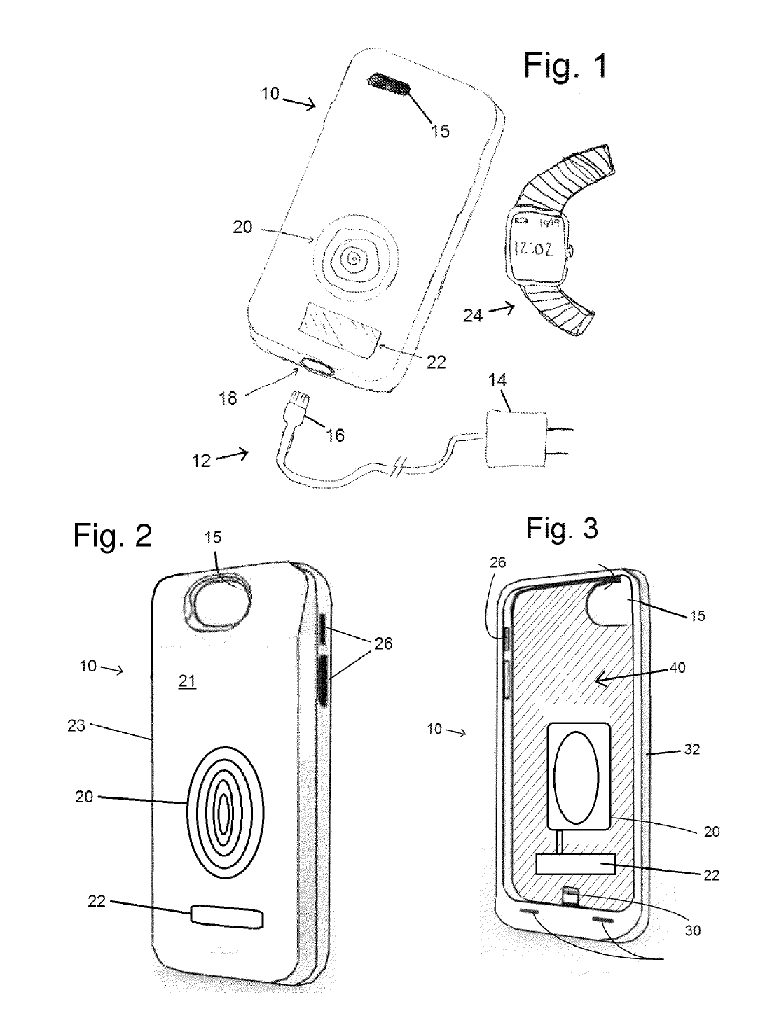

FIG. 1 shoes a phone case 10, a charging cord 12 and a smart watch 24 in accordance with the principles of the invention. A phone (not shown) may be housed within the case 10. Case 10 may be substantially similar to existing cell phone cases and/or tablet cases and may generally include a back panel 21 and a peripheral wall 32 that may extend substantially perpendicularly to the periphery 23 of the back panel 21. It may include one or more openings 15 aligning with a camera, light, speaker or other mechanisms often incorporated into a portable device. The smart watch 24 may be recharged using an inductive charging mechanism.

The case 10 may also include a charging socket 18 port that may be connected to a charging cord 12. The charging cord 12 may include a distal plug 14 adapted to connect to a common wall socket, USB port or other means for supplying electricity. The charging cord 12 may also include a proximal plug 16 adapted to connect with a phone, and electrical wiring 17 connecting the two plugs. Optionally, the charging cord 12 may include a plug 14 configured to connect with a USB or other port for supplying power.

The case 10 may also include a charging station 20. In this embodiment, the charging station 20 is positioned on the exterior of the case 10. In this embodiments, the charging station 20 is located on the back 21 of the case 10. The charging station 20 in this embodiment includes an inductive charging mechanism. This may allow the charging station 20 to recharge a secondary device without connecting to it electrically. The charging station 20 may be located at any desirable place on the case 10. Additional charging stations may be positioned in different locations about the case 10. The charging station 20 may include an inductive charging mechanism, as in this embodiment, or any other suitable charging mechanism. The portable device case 10 may also include a control pad 22. The control pad 22 may be display the charge level of a phone housed within case 10, a secondary device or both. The control pad may also include one or more switches for changing the manner in which the case 10 operates. For example, the case may be instructed to: a) charge a secondary portable device before the phone is charged, b) charge the phone and secondary device simultaneously, c) charge the phone first, then charge any secondary devices adjacent to the charging station 20, d) use the battery in the phone as a power supply to charge the secondary device e) charge the phone battery using power supplied from a charged secondary device adjacent to the charging station 20. The charging station may therefore be used both to supply power and to receive power from other devices.

Referring to FIG. 2, the front and back of the portable device charging case 10 may be seen. The case 10 may include one or more buttons 26 aligned with buttons on the phone to allow manipulation of a phone's buttons while the phone is inside the case. In this embodiment, two buttons 26 are located on the peripheral wall 32 that wraps around a device held within the case. The peripheral wall 32 extends substantially perpendicularly from the periphery 23 of the back 21 of the case 10. The position and size of opening 15 and buttons 26 may depend upon the particular device that is to be held within the case 10. In this embodiment, the control pad 22 is located substantially adjacent to and below the inductive charging station 20. The control pad 22 may optionally be located at any convenient position on the case 10.

FIG. 3 shows the interior side of the case 10. The charging plug 30 may be engaged with the recharging port on a phone or other device located within the case. Most existing portable device cases today provide simply an access port that allows a charging cord 12 to plug directly into the portable device through the opening in the case. The case 10 in accordance with the principles of the invention may include a charging socket 18 that directly engages a charging cord rather than providing access to the charging port of a phone housed within the case 10. The interior of the case 10 may include a cavity 40 configured to accommodate a phone or other portable device. The cavity 40 may be at least partially defined by the peripheral wall 32 and the back panel 21. The internal charging plug 30 may be positioned inside the cavity 40 and configured to engage a charging port on a phone when it is inserted into the cavity 40.

A separate internal charging plug 30 engages the recharging port of a device housed within the case 10. The internal charging plug 30 may be in direct electrical communication with charging socket 18, internal circuitry, the control pad 22, and the charging station 20. The charging socket 18 may be positioned proximal to the charging internal plug 30. The control pad 22 may be manipulated to reconfigure the case 10 to operate in one or more of the different modes of operation described above. When a phone is placed inside the case 10, the internal charging plug 30 may be inserted into a charging port on the phone.

The charging station 20 may preferably be aesthetically pleasing and functional. The charging station 20 and/or the side of the case on which the charging station is located may be configured to accommodate any wirelessly charged accessory or device. Optionally, the case may have one or more charging stations specifically designed to accommodate specific secondary devices. A case in accordance with the principles of the invention may also optionally include attachments designed to allow the charging station to connect with specific secondary devices. Attachments may be removably attached to the case, or may be permanently affixed.

A case in accordance with the principles of the invention may assume several other embodiments. For example, a portable device case may include a plurality of induction charging stations. A case may optionally include a plurality of differently configured charging sockets and/or a plurality of differently configured charging plugs for attachment to a device inside the case. The internal circuitry may be comprised largely of firmware, or may include software components. The portable device cases may be hermetically sealable, may include ornamentation and may include other modifications, as is known in the art.

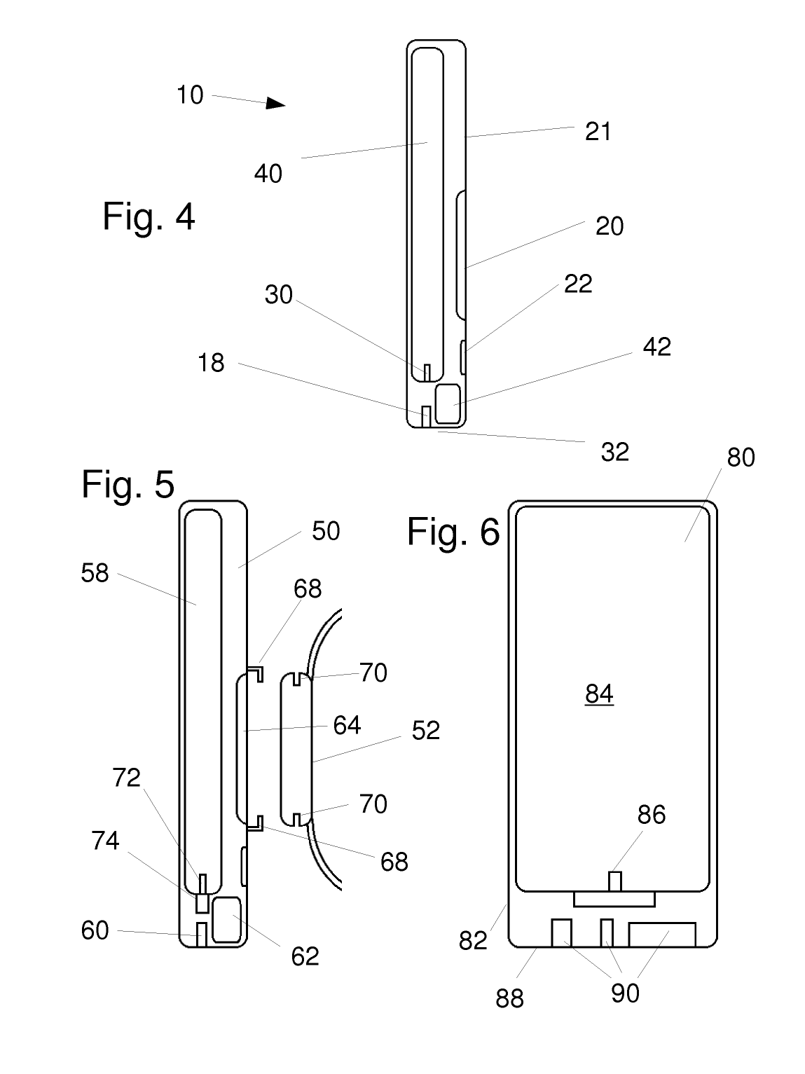

FIG. 4 shows a cross-sectional side view of the case 10. The charging station 20 and the control pad 22 may both lie flush with the back 21 of the case 10. A phone may be housed within a cavity 40 and its charging port may be engaged with internal charging plug 30. The case 10 may optionally include an ancillary battery 42. The ancillary battery 42 may be used to store additional power that may be supplied to a device within the case 10 and/or to a device charged at the charging station 20.

FIG. 5 shows a cross-sectional side view of an alternative embodiment of a case 50 and a secondary device 52 in accordance with principles of the invention. The case 50 may include a peripheral wall 54 extending substantially perpendicularly from the back 56 of the case 50. A cavity 58 may be configured to Howells a phone or other device. A charging port 60 may be connected to a charging plug to supply power to the case 50. The case 50 may then charge its own ancillary battery 62, charge a phone within the cavity 58, and/or charge a secondary device 52 using the charging station 64.

The case 52 may include tabs 68 extending from the case proximal to the charging station 64. The tabs 68 may be configured to engage slots 70 on the secondary device 52. This may hold the secondary device 52 in close proximity to the charging station 64. This may be desirable for charging a secondary device while the devices are inside a moving vehicle or an operator's pocket.

Internal charging port 72 may be interchangeable with one or more alternative internal charging ports. The internal charging plugs may be inserted into a socket 74 to place them in electrical communication with the other components of the case 50.

FIG. 6 is a front cross-sectional view of an alternative embodiment of a case 80. This embodiments also may include a peripheral wall 82, a cavity for housing a device 84 and an internal charging plug 86 that may be interchangeable with other plugs adapted to different types of devices. By utilizing interchangeable internal charging ports 86, the case may be configured to engage phones by different manufacturers having different charging ports.

The bottom 88 of the case 80 may also include a plurality of external charging ports 90. Each of the external charging ports 90 may be configured to engage a different type of charging cord having a different type of plug. This may allow charging of the case 80, a phone housed within the case 80, and a secondary device charged using a charging station to all be accomplished utilizing one or more plugs.

In use, an operator of a portable device case as described herein may choose which device or devices will be charged by the case, what order they will be charged in an from where the electrical power will be supplied to accomplish the charging of a device. The case may derive power from the battery of a phone housed within the case, a charging cord connected to an external charging port, its own internal ancillary battery, or even from a secondary device proximal to its charging station. The case may supply power to a phone housed within the case, a charging cord connected to an external charging port, its own internal ancillary battery or a secondary device proximal to a charging station.

The device may include a phone or tablet software application with which the device communicates either through the internal charging plug engaged with a phone housed within the case, Wi-Fi, Bluetooth® technology, or other means. This application may cause a phone to vibrates or omit an audio signal when one or more devices have been fully charged or when one or more devices have a very low charge.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A case for a portable device comprising:
a cavity for housing a portable device defined by a back panel and a peripheral wall extending substantially perpendicular to the back panel along the periphery of the back panel;
an external charging ports;
an internal charging plug located within the cavity; and,
an external charging station.

2. The case for a portable device of claim 1 further comprising an internal ancillary battery.

3. The case for a portable device of claim 1 wherein the charging station includes a mechanism for inductive charging.
